(19) United States
(12) Patent Application Publication
(10) Pub. No.: US 2025/0191382 A1
(43) Pub. Date: Jun. 12, 2025

(54) METHOD FOR RECOGNIZING A BOUNDARY OBJECT OF A ROAD AND A VEHICLE USING THE SAME

(71) Applicants: HYUNDAI MOTOR COMPANY, Seoul (KR); KIA CORPORATION, Seoul (KR)

(72) Inventor: Keon Woo Jang, Namyangju-si (KR)

(73) Assignees: HYUNDAI MOTOR COMPANY, Seoul (KR); KIA CORPORATION, Seoul (KR)

(21) Appl. No.: 18/763,513

(22) Filed: Jul. 3, 2024

(30) Foreign Application Priority Data
Dec. 12, 2023 (KR) 10-2023-0179397

(51) Int. Cl. G06V 20/56; G06V 10/98

(52) U.S. Cl. CPC G06V 20/588; G06V 10/98

(57) ABSTRACT

A method for recognizing a boundary object of a road includes sensing an environment around a vehicle by an environment perception sensor that includes a laser scanning-based three-dimensional recognition sensor and a sensor of a different type. The method also includes determining candidate detection data from abnormal detection data that is perceived to be abnormal by the three-dimensional recognition sensor and is unassociated with an internal static object of a road and an internal dynamic object of the road, by referring to a boundary region. The method also includes adopting estimated boundary data that is considered as a road boundary object in the candidate detection data, based on distribution information of normal boundary data that is normally perceived in relation to the road boundary object by the three-dimensional recognition sensor. The method also includes employing the normal boundary data and the estimated boundary data as boundary data.

### CROSS REFERENCE TO RELATED APPLICATION

This application claims priority to and benefit of a Korean patent application 10-2023-0179397, filed Dec. 12, 2023, the entire contents of which are incorporated herein for all purposes by this reference.

### TECHNICAL FIELD

The present disclosure relates to a method for recognizing a road boundary object and relates to a vehicle using the same. In addition, the present disclosure relates to a method and a vehicle for ensuring safety of autonomous driving and improving user experience by extending processing of autonomous driving to abnormal detection data.

### BACKGROUND

Recently, commercial vehicles tend to be equipped with autonomous deriving functions for driving convenience. Autonomous driving functions are being developed to realize the full autonomous driving. By using the full autonomous driving, a vehicle has full control of driving without driver intervention in any situation. Before the full autonomous driving stage is entered, some functions of full autonomous driving are utilized in commercial vehicles.

The autonomous driving is capable of processing perceptions that detect a surrounding environment and estimate a location of a vehicle, processing decisions on a driving operation based on a perceived environment and an estimated location, and processing control of an actuator according to a determined operation. Among the above processes, the perceptions may be performed using fusion of multiple sensors. For example, the multiple sensors may include an image sensor, e.g., a camera, a Lidar sensor for obtaining a three-dimensional shape of a neighbor object, or a radar sensor for detecting the presence, distance, and motion of a neighbor object.

A Lidar sensor provides a precise three-dimensional point cloud for a neighbor object by using ambient scanning based on a multi-channel laser and thus has good measurement performance, excellent 3D form recognition performance, and robustness against weather, as compared to other sensors. For recognition of a location of an object, a vehicle recognizes the object, for example, a road boundary of a driving road, by using the Lidar sensor together with the image sensor and the radar sensor in a combined way. However, the Lidar sensor has a high degree of recognition for a short-distance environment but tends to show a sharp decline in recognizing a long-distance environment.

When the Lidar sensor is used to recognize an object at a distance from a vehicle, for example, a road boundary, recognition failure may occur since the road boundary is not perceived, or a misrecognition error may occur because a recognized road boundary does not actually exist. Accordingly, for accurate location recognition of autonomous driving, Lidar data about short-distance road boundaries with relatively higher reliability, i.e., point clouds of a Lidar sensor, are mainly used, while Lidar data about long-distance road boundaries are not used.

For more accurate decision and control of driving behaviors, it is desirable that an autonomous driving vehicle estimates a stable location through surroundings perception over a wide range. However, conventionally, since recognition results in long-distance Lidar data are lost and only short-distance Lidar data is used to estimate a vehicle location, the driving behavior and path generation of an autonomous driving vehicle are unstably established, and a user's experience level is remarkably degraded.

### SUMMARY

The present disclosure provides a recognition method for a road boundary object for increasing utilization of detection data of a laser scanning-based three-dimensional recognition sensor by using detection data abnormally perceived in the three-dimensional recognition sensor as valid detection data through fusion with other sensor data. The present disclosure is also directed to a vehicle using the method.

In addition, the present disclosure is directed to a method and a vehicle for ensuring safety of autonomous driving and improving user experience by extending processing of autonomous driving to abnormal detection data.

The technical problems solved by the present disclosure are not limited to the above technical problems. Other technical problems, which are not described herein, should be clearly understood by a person having ordinary skill in the technical field, to which the present disclosure belongs, from the present disclosure.

According to an embodiment of the present disclosure, a method for recognizing a road boundary object comprises sensing an environment around a vehicle by an environment perception sensor. The environment perception sensor comprises a laser scanning-based three-dimensional recognition sensor and a sensor of a different type from the laser scanning-based three-dimensional recognition sensor. The method further includes determining candidate detection data from abnormal detection data that is perceived to be abnormal by the laser scanning-based three-dimensional recognition sensor and is unassociated with an internal static object of a road and an internal dynamic object of the road, by referring to a boundary region for perceiving a road boundary object. The method further includes adopting estimated boundary data that is considered as a road boundary object in the candidate detection data, based on distribution information of normal boundary data that is normally perceived in relation to the road boundary object by the laser scanning-based three-dimensional recognition sensor. The method also includes employing the normal boundary data and the estimated boundary data as boundary data.

According to an embodiment of the present disclosure, the method may further include configuring the abnormal detection data as abnormal detection data located within a first spatial range in which the road boundary object is possible to exist.

According to an embodiment of the present disclosure, determining the candidate detection data may include selecting abnormal detection data within a first spatial range in which the road boundary object is possible to exist. Determining the candidate detection data may further include removing, based on an image data of the environment perception sensor, abnormal detection data within a second spatial range associated with the internal static object from the selected abnormal detection data. Determining the candidate detection data may further include removing abnormal detection data associated with the internal dynamic object from the selected abnormal detection data, based on at least one of the image data or change information of the internal dynamic object. Determining the candidate detection data may further include determining candidate detection data by filtering abnormal detection data that remains after removal, by referring to the boundary region based on the road boundary object identified from the image data.

According to an embodiment of the present disclosure, the environment perception sensor may include a camera configured to obtain an image of the environment and a radar sensor configured to detect a behavior of an object that belongs to the environment. The method may further include obtaining the image data by the camera or the laser scanning-based three-dimensional recognition sensor and obtaining the change information by the radar sensor.

According to an embodiment of the present disclosure, removing the abnormal detection data associated with the internal dynamic object may include removing abnormal detection data that remains in a predetermined region behind a neighbor dynamic object based on a driving direction of the neighbor dynamic object driving near the vehicle.

According to an embodiment of the present disclosure, the method may further include setting the boundary region to make an external region of the road larger than an internal region facing the road, based on a predetermined line of the road boundary object adjacent to the road identified in the image data.

According to an embodiment of the present disclosure, the first spatial range and the second spatial range may be same. The first spatial range and the second spatial range may be a range of a data space of a three-dimensional recognition data corresponding to a range of height in which the road boundary object is located from a reference ground origin of the road. The data space may be defined as a space system in which the three-dimensional recognition data exists.

According to an embodiment of the present disclosure, adopting the estimated boundary data may include generating a plurality of candidate boxes on the candidate detection data based on the distribution information of the normal boundary data. Adopting the estimated boundary data may further include determining whether or not insufficiency, in which a point cloud density in the candidate boxes is equal to or less than a threshold density, successively occurs a predetermined number of times or more. Adopting the estimated boundary data may further include, in response to an occurrence of successive insufficiency, adopting the candidate detection data, which belongs to a candidate box preceding a candidate box, in which the successive insufficiency begins, to be considered the estimated boundary data. Adopting the estimated boundary data may further include, in response to a non-occurrence of the successive insufficiency, adopting the candidate detection data, which belongs to a candidate box preceding an insufficient candidate box and a candidate box following the insufficient candidate box, to be considered the estimated boundary data.

According to an embodiment of the present disclosure, the method may further include determining the candidate detection data associated with a static object as the estimated boundary data, based on an object attribute of the adopted candidate detection data.

According to an embodiment of the present disclosure, the method may further include determining a location of the vehicle based on at least the boundary data.

According to another embodiment of the present disclosure, a vehicle for recognizing a road boundary object includes a sensor unit equipped with an environment perception sensor. The environment perception sensor includes a laser scanning-based three-dimensional recognition sensor and a sensor of a different type from the laser scanning-based three-dimensional recognition sensor in order to sense a surrounding environment of the vehicle. The vehicle also includes a memory configured to store at least one instruction for the vehicle. The vehicle also includes a processor configured to execute the at least one instruction stored in the memory. The processor is further configured to determine candidate detection data from abnormal detection data that is perceived to be abnormal by the laser scanning-based three-dimensional recognition sensor and is unassociated with an internal static object of a road and an internal dynamic object of the road, by referring to a boundary region for perceiving the road boundary object. The processor is further configured to adopt estimated boundary data that is considered as a road boundary object in the candidate detection data, based on distribution information of normal boundary data that is normally perceived in relation to the road boundary object by the laser scanning-based three-dimensional recognition sensor. The processor is further configured to employ the normal boundary data and the estimated boundary data as boundary data.

The features briefly summarized above for the present disclosure are only illustrative aspects of the following detailed description and are not intended to limit the scope of the present disclosure.

The technical problems solved by the present disclosure are not limited to the above technical problems. Other technical problems, which are not described herein, should be clearly understood by a person having ordinary skill in the technical field, to which the present disclosure belongs (hereinafter referred to as an ordinary person), from the present disclosure.

According to the present disclosure, a recognition method and a vehicle using the method for a road boundary object may increase utilization of detection data of a laser scanning-based three-dimensional recognition sensor by using detection data abnormally perceived in the laser scanning-based three-dimensional recognition sensor as valid detection data through fusion with other sensor data.

In addition, according to the present disclosure, a method and a vehicle may ensure safety of autonomous driving and improve user experience by extending processing of autonomous driving to abnormal detection data.

The effects obtainable from the present disclosure are not limited to the above-mentioned effects, and other effects not mentioned herein should be clearly understood by those having ordinary skill in the art through the present disclosure.

### BRIEF DESCRIPTION OF DRAWINGS

FIG. 1 is a view illustrating a vehicle communicating with another device to transmit and receive data.

FIG. 2 is a view showing constituent modules of a vehicle according to an embodiment of the present disclosure.

FIG. 3 is a flowchart of a method for recognizing a road boundary object according to another embodiment of the present disclosure.

FIG. 4 is a view illustrating abnormal boundary data and abnormal detection data that are perceived to be normal and abnormal respectively for a road boundary object in a three-dimensional (3D) recognition sensor.

FIG. 5 is a flowchart of a procedure for determining candidate detection data.

FIG. 6 is a view illustrating selection of abnormal detection data in a first spatial range where a road boundary object may exist.

FIG. 7 is a view illustrating abnormal detection data of an internal dynamic object of a road located in a second spatial range in front of a vehicle.

FIG. 8 is a view illustrating removal of abnormal detection data of an internal dynamic object of a road.

FIG. 9 is a view illustrating removal of abnormal detection data associated with an internal dynamic object based on image data.

FIG. 10 is a view showing an example of a boundary region of image data based on a road boundary object.

FIG. 11 is a view showing another example of a boundary region of image data based on a road boundary object.

FIG. 12 is a flowchart of a procedure for determining estimated boundary data.

FIG. 13 is a view illustrating a candidate box generated on candidate detection data.

FIG. 14 is a view illustrating an example of selecting a candidate box and adopting candidate detection data.

FIG. 15 is a view illustrating another example of selecting a candidate box and adopting candidate detection data.

FIG. 16 is a view illustrating determination of estimated boundary data based on an object attribute of candidate detection data.

FIG. 17 is a view illustrating boundary data including normal boundary data and estimated boundary data.

### DETAILED DESCRIPTION

Hereinafter, embodiments of the present disclosure are described in detail with reference to the accompanying drawings so that those having ordinary skill in the art may easily implement the present disclosure. However, the present disclosure may be implemented in various different ways and is not limited to the embodiments described therein.

In describing embodiments of the present disclosure, well-known functions or constructions are not described in detail since they may unnecessarily obscure the understanding of the present disclosure. The same or equivalent constituent elements in the drawings are denoted by the same reference numerals, and a repeated description of the same elements has been omitted.

In the present disclosure, when an element is simply referred to as being “connected to”, “coupled to”, or “linked to” another element, this may mean that the element is “directly connected to”, “directly coupled to”, or “directly linked to” the another element or is connected to, coupled to, or linked to the another element with an element intervening therebetween. In addition, when an element “includes” or “has” another element, this means that the element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed as a second element in another embodiment, and similarly, a second element in an embodiment could be termed as a first element in another embodiment, without departing from the scope of the present disclosure.

In the present disclosure, elements that are distinguished from each other are for clearly describing each feature and do not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment including a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them should become apparent with reference to embodiments described below in detail in conjunction with the accompanying drawings. Embodiments, however, may be embodied in many different forms and should not be constructed as being limited to the embodiments set forth herein. Rather, these embodiments are provided so that the present disclosure may be complete and may fully convey the scope of the present disclosure to those having ordinary skill in the art.

In the present disclosure, each of phrases such as “A or B”, “at least one of A and B”, “at least one of A or B”, “A, B or C”, “at least one of A, B and C”, “at least one of A, B or C” and “at least one of A, B, C or combination thereof” may include any one or all possible combinations of the items listed together in the corresponding one of the phrases. For example, the phrase such as “at least one of A, B, or C, or any combination thereof” may include “A”, “B”, or “C”, or “AB” “BC” or “ABC”, which is a combination thereof. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Hereinafter, embodiments of the present disclosure is described with reference to the accompanying drawings.

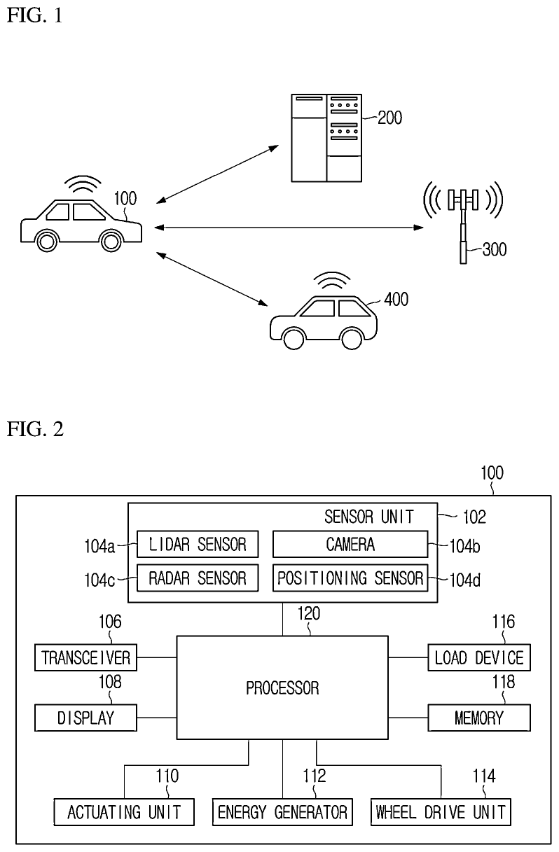

Hereinafter, referring to FIG. 1 and FIG. 2, a vehicle implementing autonomous driving by recognizing a road boundary object will be described. FIG. 1 is a view illustrating a vehicle communicating with another device to transmit and receive data.

Referring to FIG. 1 and FIG. 2, a vehicle 100 may be driven based on electric energy or fossil energy. In the case of electric energy, for example, the vehicle 100 may be a pure battery-based vehicle driven only by a high-voltage battery or employ a gas-based fuel cell as an energy source. In addition, a fuel cell may use various types of gas capable of generating electric energy, and for example, the gas may be hydrogen. However, without being limited thereto, various gases may be applicable. In the case of fossil energy, the vehicle 100 is driven based on fuels, such as gasoline, diesel, or liquefied gas, and may be equipped with an engine that drives a wheel drive unit 114 by combustion of the fuel. The engine may be included in an energy generator 112 to provide a driving torque of a wheel to the wheel drive unit 114.

For convenience of explanation, the present disclosure describes the vehicle 100 as an example vehicle based on electric energy, but except regenerative braking, charge, and discharge described in the present disclosure, an embodiment of the present disclosure may certainly be applicable to a vehicle based on fossil energy.

The vehicle 100 may refer to a device capable of moving. The vehicle 100 is a vehicle as a ground vehicle driven on the ground and may be a normal passenger vehicle or commercial vehicle, a purpose built vehicle (PBV), and the like. The vehicle 100 may be a four-wheel vehicle, for example, a sedan, a sports utility vehicle (SUV), and a pickup truck and may also be a vehicle with five or more wheels, for example, a bus, a lorry, a container truck, and a heavy vehicle.

The vehicle 100 may be driven by being controlled in autonomous driving, and the autonomous driving may be implemented as semi-autonomous driving or full autonomous driving. Full autonomous driving may be provided as autonomous moving under the complete control of a processor 120 of the vehicle 100 without a user's intervention even in an uncertain driving situation. Semi-autonomous driving may be provided as autonomous moving that requires a driver's intervention in a specific driving situation. When the driving situation occurs, semi-autonomous driving may be implemented such that the processor 120 disables autonomous driving and switches control to the user, and thus the user performs manual driving. According to the autonomous driving levels defined by the Society of Automotive Engineers (SAE), semi-autonomous driving may correspond to the autonomous driving levels 1 to 4, and full autonomous driving may correspond to the level 5.

Meanwhile, the vehicle 100 may perform communication with other devices 200 and 300 or another vehicle 400. For example, another device may include a server 200 for supporting various control, state management and driving of the vehicle 100, an ITS device 300 for receiving information from an intelligent transportation system (ITS), and various types of user devices. For example, the server 200 is an external device operated by a vehicle manufacturer or provided for an autonomous driving service and may receive connected data of the vehicle 100 or transmit data necessary for autonomous driving. In order to support autonomous driving and various services for the vehicle 100, the server 200 may transmit various types of information and software modules used for controlling the vehicle 100 to the vehicle 100 as a response to a request and data transmitted from the vehicle 100 and a user device.

For example, the ITS device 300 may be a road side unit (RSU), and the ITS device 300 may assist a user in driving his own car or support autonomous driving of the vehicle 100 by exchanging vehicle recognition data, driving control and situation data, environment data surrounding a vehicle, and map data through V2I with the vehicle 100. Through V2V with another vehicle 400, the vehicle 100 may support a driver's driving his own car or autonomous driving by exchanging the above-listed data.

The vehicle 100 may communicate with another vehicle or another device based on cellular communication, wireless access in vehicular environment (WAVE) communication, dedicated short range communication (DSRC), short range communication, or any other communication scheme.

For example, the vehicle 100 may use LTE as a cellular communication network, a communication network such as 5G, a WiFi communication network, a WAVE communication network, and the like to communicate with the server 200, the ITS device 300, and another vehicle 400. As another example, DSRC used in the vehicle 100 may be used for vehicle-to-vehicle communication. A communication scheme among the vehicle 100, the server 200, the ITS device 300, the other vehicle 400, and a user device is not limited to the above-described embodiment.

FIG. 2 is a view showing constituent modules of a vehicle according to an embodiment of the present disclosure.

The vehicle 100 may include a sensor unit 102, a transceiver 106, and a display 108.

The sensor unit 102 may be equipped with various types of detectors for sensing various states and situations occurring in external and internal environments of the vehicle 100 and for identifying location information of the vehicle 100. In other words, the sensor unit 102 may be configured as a multiple sensor module including heterogeneous sensors to obtain sensing data detected from each of the sensors.

Specifically, the sensor unit 102 may be equipped with a camera 104b and a radar sensor 104c for recognizing dynamic and static objects present around the vehicle 100 and have a positioning sensor 104d capable of obtaining location information of a vehicle. The sensor unit 102 may obtain sensor data including three-dimensional recognition data, perception/observation data, and positioning information by the above-described sensors. A three-dimensional (3D) perception sensor corresponds to a Lidar sensor, and these two terms may be used interchangeably below. Perception/observation data may include image data for a camera and radar data.

The Lidar sensor 104a may be a type of 3D recognition sensor according to the present disclosure, and the terms ‘Lidar sensor’ and ‘3D recognition sensor’ may be used interchangeably below. The Lidar sensor 104a may be a sensor that observes a surrounding environment based on laser scanning and perceives a three-dimensional shape of an object. Specifically, the Lidar sensor 104a may obtain three-dimensional recognition data for a surrounding environment and an object by scanning laser around the moving object 100. Three-dimensional recognition data may include a point cloud representing a three-dimensional shape of an object, i.e., detection data and image data for observation representing a surrounding environment. For example, detection data may be provided to identify each object by representing three-dimensional contours and shapes of objects and an arrangement of objects. For example, image data may be provided to identify an object and a surrounding environment through images of the object and the surrounding environment.

The camera 104b may obtain two-dimensional (2D) image data or image data with depth information for a surrounding environment of the vehicle 100 and an object. For example, the radar sensor 104c may irradiate an electromagnetic wave with a predetermined wavelength and thus detect a behavior of an object based on an electromagnetic wave reflected from the object. For example, the behavior of an object may include the presence of the object, whether the object moves, a distance between the vehicle 100 and the object, a speed of the object, and a movement direction.

Apart from the positioning sensor 104d, the sensor unit 102 may be equipped with a gyro sensor, an acceleration sensor, a wheel sensor, an autometer, a speed sensor and the like, in order to identify its own location, driving position, and speed. In addition, to monitor a user inside the vehicle 100, a condition of an occupant, and an operating situation of an internal device of the vehicle 100 that a user is capable of maneuvering, the sensor unit 102 may have the camera 104 facing the inside, a biosensor for detecting bio signals of a driver and an occupant, and various detection modules for detecting the operation and state of an internal device.

The present disclosure mainly describes sensors of the sensor unit 102 for description of an embodiment and may further include a sensor for detecting various situations not listed herein.

The transceiver 106 may support mutual communication with the server 200, the ITS device 300, and the neighbor vehicle 400. In the present disclosure, the transceiver 106 may transmit data generated or stored during driving to the server 200 and receive data and a software module transmitted from the server 200. In the present disclosure, the vehicle 100 may transmit and receive data used in a method according to the present disclosure to and from the outside through the transceiver 106.

The display 108 may serve as a user interface. By the processor 120, the display 108 may display an operating state and a control state of the vehicle 100, path/traffic information, information on an energy remaining quantity, a content requested by a driver, and the like to be output. The display 108 may be configured as a touch screen capable of sensing a driver input and receive a request of a driver indicated to the processor 120.

A user may activate or deactivate an autonomous driving function through a soft-type interface like a touch of the display 108 or a hard-type interface provided in a predetermined position inside the vehicle 100. In the case of a hard-type interface, for example, a button or key for an autonomous driving function may be installed on a steering wheel, a dashboard, and the like. In addition, the interfaces may be configured to provide detailed options for selecting various functions provided at a corresponding level of autonomous driving.

Meanwhile, the vehicle 100 may include an actuating unit 110, the energy generator 112, the wheel drive unit 114, and a load device 116.

The actuating unit 110 may be equipped with at least one module for implementing a driving operation and may perform at least one driving operation of longitudinal control like acceleration/deceleration and transverse control like steering. The actuating unit 110 may be equipped with not only a pedal and a steering wheel accepting a user's request for the control but also various operating modules for generating a driving operation according to the request in the wheel drive unit 114.

The energy generator 112 may generate and supply power and electricity used for a driving power system like the wheel drive unit 114 and the load device 116. In a case that the vehicle 110 is driven based on electric energy, for example, the energy generator 112 may be configured as an electric battery or be configured as a combination of an electric battery and a fuel cell for charging the battery. In the case of a combination of an electric battery and a fuel cell, the energy generator 112 may include a tank for storing a material used to produce power of the fuel cell, for example, hydrogen gas. In case the vehicle 100 is driven based on fossil energy, the energy generator 112 may be configured as an internal combustion engine.

The wheel drive unit 114 may include a plurality of wheels, a driving force transfer module for generating and giving a driving force to wheels or for transferring a driving force, a braking module for decelerating the driving of wheels, and a steering module for realizing transverse control of wheels. In case the vehicle 100 is driven based on electric energy, the driving force transfer module may be configured as a motor module that generates a driving force based on power output from an electric battery. In case the vehicle 100 is operated based on fossil energy, a driving force transfer module may be equipped with transmission and a gear module that transfer power of an internal combustion engine.

The load device 116 may be an auxiliary equipment mounted on the vehicle 100, which consumes power supplied from the energy generator 112 by use of an occupant or user or converted from output of the energy generator 112. The load device 116 may be a type of electric device for non-driving purpose excluding a driving power system like the wheel drive unit 114 in the present disclosure. For example, the load device 114 may be various devices installed in an air-conditioning system, a light system, a seat system and the vehicle 100.

In addition, the vehicle 100 may include the memory 118 and the processor 120.

The memory 118 may store an application for controlling the vehicle 100 and various data and load the application or read and record data at a request of the processor 120. In the present disclosure, the memory 118 may store an application and at least one instruction for filtering abnormal detection data associated with an internal dynamic object of a road from abnormal detection data, which is perceived to be abnormal in the Lidar sensor 104a. The memory 118 may store an application and at least one instruction for selecting residual abnormal detection data as candidate detection data. The memory 118 may store an application and at least one instruction for adopting estimated boundary data that is considered a boundary object of the road in the candidate detection data, according to distribution information of normal boundary data, which is normally perceived in relation to a boundary object of the road in the Lidar sensor 104a. The memory 118 may store an application and at least one instruction for merging the estimated boundary data with the normal boundary data.

To this end, the memory 118 may have a learning model for processing, e.g., distinguishing, an object and an environment around the vehicle 100, identifying their occupancy and behaviors, and tracking their occupancy and behaviors. A learning model may be constructed by training a predetermined algorithm for learning, for example, a deep neural network such as CNN and RNN, based on static and dynamic objects that are identified through existing 3D recognition data, image data for a camera, radar data, and location data that are collected from the vehicle 100, the server 200 and another vehicle 400. A learning model may be set up as a specific model based on learning results of the algorithm or be established through an update of a set-up model. Such a learning model may process an object and an environment based on the above-described data, which are recognized in real time during driving, and a model.

Herein, an object may be a static object or a dynamic object. A static object may be an object without mobility such as a fixed facility. A dynamic object may be an object with mobility such as a pedestrian, a vehicle, and another type of a moving object.

In the present disclosure, a static object may include an external static object located outside a road, an internal static object inside the road, and a road boundary object that divides the road.

An external static object may be a facility placed outside a road for vehicles and may be, for example, a building, a walkway, a roadside tree, an installed structure for serving also as a line on a road, and other fixed facilities. For example, an installed structure may function as a center line or a line dividing sub-lanes in a same direction on a wide road with a plurality of lanes. An installed structure may be formed to have various structures occupying a considerable area.

An internal static object is an object included in road information and may include, for example, a road surface, notice information for traffic control such as a line or a traffic mark, a sign post installed on a road, a traffic sign and the like. For example, a traffic mark may be a driving direction line, a crosswalk, a speed limit, and a U-turn.

A road boundary object is an object included in road information and may be an additional facility provided as a boundary that distinguishes a road for vehicles and a zone where no vehicle is driving. As an example, a road boundary object may be placed on both sides of a road, that is, a zone where no vehicle is driving and which is adjacent to the sidewalk. As another example, a road boundary object may be placed in a non-driving zone provided inside a large road in order to divide the large road into sub-roads. For example, a road boundary object may be implemented by a curb, a guardrail, a boundary stone, a boundary block structure, a shock absorbing structure, and a rail for road, and any object, which serves to distinguish a road for vehicles and a non-driving zone, is not limited to the above-described example.

In the present disclosure, a dynamic object may include an external dynamic object, which moves outside a road, and an internal dynamic object that moves inside a road. For example, an external dynamic object may be a pedestrian, a bicycle, a personal mobility, and any other means of mobility that walk or move in a non-driving zone outside a road, for example, in a sidewalk. An internal dynamic object may be another vehicle, various forms of mobility means, and the like, which are driven around the vehicle 100 inside a road.

Meanwhile, the memory 118 may store and manage map information. Map information may be used to generate a driving path set to the vehicle 100 at a request of a user or the processor 120. In addition, map information may be used for autonomous driving and include a low definition map or include an HID map together with the map. Map information may be provided to have various information and data included in the above-described object and environment.

The processor 120 may perform overall control of the vehicle 100. The processor 120 may be configured to execute an application and an instruction stored in the memory 118. The processor 120 may activate autonomous driving in response to an autonomous driving request by a user or a setting of the vehicle 100 itself and may control the vehicle 100 to activate autonomous driving at a level applied to the vehicle 100. In addition, the processor 120 may deactivate autonomous driving by a user's release or at a request according to automatic release and may control the vehicle 100 to be manually driven.

In the present disclosure, the processor 120 may determine candidate detection data from abnormal detection data that is perceived to be abnormal in the Lidar sensor 104a and are not associated with internal static objects of a road and internal dynamic objects of the road, by using an application, an instruction, and data stored in the memory 118 and with reference to a boundary region for recognition of a road boundary object. The processor 120 may adopt estimated boundary data that is considered a road boundary object in candidate detection data, based on distribution information of normal boundary data that is normally perceived in the Lidar sensor 104a in relation to a road boundary object. The processor 120 may employ normal boundary data and estimated boundary data as boundary data and estimate a location of the vehicle 100 based on all the boundary data of a road boundary object and map information.

In the present disclosure, as an example, the processor 120 may be implemented as a single processing module. As another example, the above functions may be performed in a plurality of processing modules, and the processor 120 in the present disclosure may collectively refer to the plurality of processing modules.

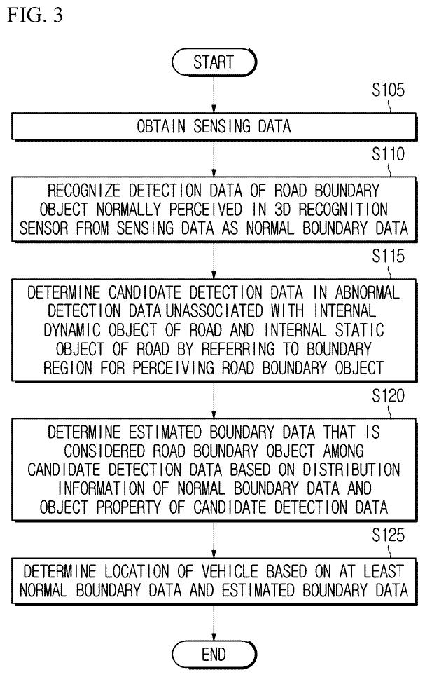

The above-described functions of the processor 120 are described in detail through FIG. 3-FIG. 17.

FIG. 3 is a flowchart of a method for recognizing a road boundary object according to another embodiment of the present disclosure. In the present disclosure, the vehicle 100 is described mainly to be operated by semi-autonomous driving or full autonomous driving and may also be applied to manual driving.

First, the sensor unit 102 may obtain sensor data associated with a surrounding environment of a vehicle, a vehicle location, and a state inside the vehicle by using the Lidar sensor 104a corresponding to the 3D recognition sensor 104a, the camera 104b, the radar sensor 104c, the positioning sensor 104d, and any other sensor (S105).

Specifically, sensing data in the present disclosure may include three-dimensional recognition data, image data for a camera, radar data, and location data. Three-dimensional recognition data may include a point cloud representing a three-dimensional shape of an object, i.e., detection data and image data for observation representing a surrounding environment. For example, detection data may be provided to identify each object by representing three-dimensional contours and shapes of objects and an arrangement of objects. For example, image data for observation may be provided to identify an object and a surrounding environment through images of the object and the surrounding environment. Image data for a camera may be two-dimensional (2D) image data for an object or image data with depth information. Radar data may be provided to detect a behavior of an object. For example, the behavior of an object may include the presence of the object, whether the object moves, a distance between the vehicle 100 and the object, a speed of the object, and a movement direction.

Next, the processor 120 may recognize and extract abnormal boundary data that is normally perceived in relation to a boundary object of a road, by analyzing a point cloud, i.e., detection data obtained from the 3D recognition sensor 104a (S110).

For example, the processor 120 may mutually match detection data, image data for observation of the 3D recognition sensor 104a, image data for a camera, and radar data and may perform geometric transformation between these data. For example, these data may be matched by using a feature of each of the data. The processor 120 may sort each of the data in a same space system through calibration of geometrically transformed data. By using a learning model, for example, the processor 120 may identify a neighbor object and an environment included in data of a same space system and may check detection data corresponding to the identified object and environment.

The processor 120 may select normal boundary data that is normally perceived, by analyzing detection data associated with a road boundary object among identified objects. In addition, the processor 120 may extract normal detection data that is normally perceived, by analyzing detection data associated with a different object from a road boundary object. As normal detection data is fused with image data for a camera, radar data, and location data, which are present in a same space system, the processor 120 may use the normal detection data fused with other data to estimate a location of the vehicle 100 that is operated by autonomous driving.

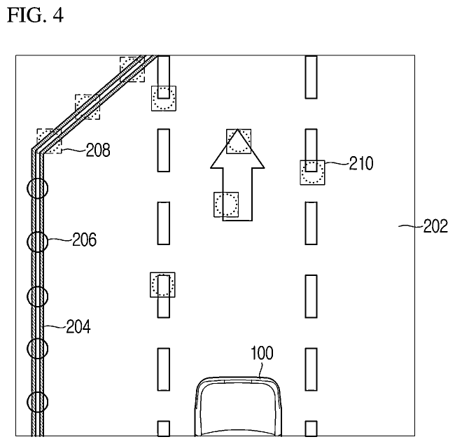

FIG. 4 is a view illustrating abnormal boundary data and abnormal detection data that are perceived to be normal and abnormal respectively for a road boundary object in a three-dimensional (3D) recognition sensor.

Referring to the example of FIG. 4, the processor 120 may identify a plurality of detection data, which is estimated to be an additional facility distinguishing a road 202 and a zone where the vehicle 100 is not driving, i.e., a road boundary object 204, and may determine whether or not each piece of the detection data is normally perceived.

In this regard, because of a characteristic of the Lidar sensor 104a, detection data (or point cloud) of an object in a predetermined distance or a farther distance is likely to be abnormally perceived and may be considered an unstable Lidar point. In addition, since a Lidar sensor generates detection data with much noise because of an object attribute like object reflectance causing diffused reflection and a trace according to a motion of a dynamic object, such detection data may be determined to be abnormal. Noise may be caused based on various properties and a property of a dynamic object, apart from the above-described reflectance and trace. In addition, detection data belonging to a point cloud density less than a normal threshold may be determined to be abnormal. In addition, detection data, which is spaced from a location of an object provided from other sensing data or is generated irrespective thereof, may be determined to be abnormal. Besides, in a point cloud distribution chart of detection data, detection data, which belongs to a region excessively spaced from other sets without association therewith, may be determined to be abnormal.

According to the abnormal examples listed above, detection data, which exists in a data space range, i.e., within a predetermined spatial range from the vehicle 100, may be considered normal perception. Herein, the data space range may be a range in a space system where 3D recognition data, for example, detection data is sorted. As another example, regardless of a distance to the vehicle 100, detection data, which has a higher point cloud density than a normal threshold and is in a region overlapping other sensing data in a predetermined range, may be determined to be normally perceived.

Referring to FIG. 4, detection data of the road boundary object 204, which exists in a data space range, i.e., within a predetermined spatial range from the vehicle 100, may be determined to be normally perceived and thus may be selected as normal boundary data 206. On the other hand, detection data of the road boundary object 204 exceeding a predetermined distance range may be estimated to be abnormally perceived and thus be considered abnormal detection data 208. In addition, even detection data within a predetermined distance range may be determined to be abnormal, if the detection data is detection data of an internal static object in a region exceeding a predetermined range from other sensing data. Detection data, which is determined to be abnormal, may be treated as abnormal detection data 210 of an internal static object.

To sum up, the processor 120 may select the normal boundary data 206 of the road boundary object 204 and also leave the abnormal detection data 210 of an internal static object of a road other than the road boundary object 204. Herein, normal detection data of an internal static object may be excluded to be used for other processing. Meanwhile, in order to subsequently process filtering through accurate analysis of detection data, the processor 120 may leave detection data of an internal dynamic object such as a neighbor vehicle running on the road 202 and detection data of an external object of the road. As another example, normal detection data of an internal dynamic object and normal detection data of an external object may be excluded.

In the present disclosure, step S110 is described to be performed prior to determination of candidate detection data according to step S115, but step S110 may also be performed prior to determination of estimated boundary data according to step S120.

Next, the processor 120 may determine candidate detection data from the abnormal detection data 208 that is perceived to be abnormal in the 3D recognition sensor 104a and is not associated with an internal static object of a road and an internal dynamic object of the road, by referring to a boundary region for recognizing the road boundary object 204 (S115).

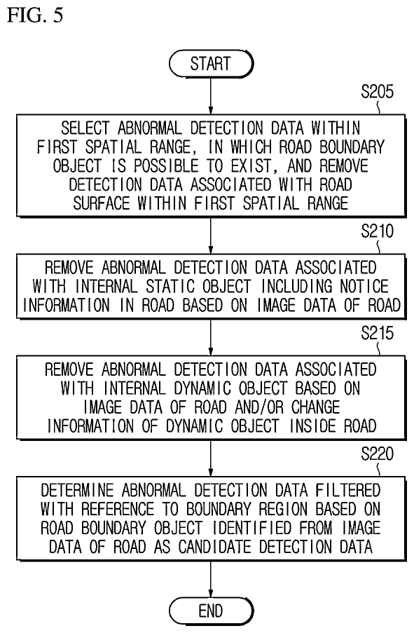

Regarding step S115, FIG. 5 is described below. FIG. 5 is a flowchart of a procedure for determining candidate detection data.

First, the processor 120 may select abnormal detection data within a first spatial range, where the road boundary object 204 may exist, and may remove detection data associated with a road surface within the first spatial range (S205).

The processor 120 may filter abnormal detection data beyond the first spatial range among abnormal detection data that are obtained from the 3D recognition sensor 104a and are distributed at least in a space system. Thus, the processor 120 may leave abnormal detection data within the first spatial range. The space system is a coordinate system where 3D recognition data exist and, for example, may be the above-described calibrated space system. The first spatial range may be a range of data space of 3D recognition data corresponding to a range of heights where the road boundary object 204 is located from a reference ground origin of the road 202.

In addition, for example, a reference ground origin may be a ground original of a current driving road. In a ramp where the ground of a front road is higher than the ground of a current driving road, a first spatial range set according to the current driving road may not cover a road boundary object of the front road. Accordingly, by the processor 120, the first spatial range may be set to have a height range above a height at which the road boundary object 204 is located from a ground origin of the current driving road.

On the other hand, in a ramp where the ground of a front road is lower than the ground of a current driving road, a first spatial range may be set by the processor 120 to have a starting point lower than a ground origin of the current driving road.

In case a path is set beforehand in autonomous driving, the processor 120 may change a first spatial range based on a predicted gradient of a front road. A first spatial range may be set based on a facility with a maximum height or a maximum size among the above-exemplified facilities as a road boundary object.

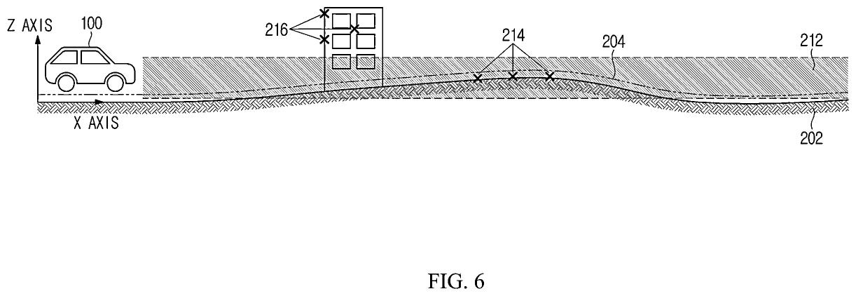

FIG. 6 is a view illustrating selection of abnormal detection data in a first spatial range where a road boundary object may exist.

The processor 120 may identify a first spatial range 212 where the road boundary object 204 obtained from the 3D recognition sensor 104a may exist in a space system. The first spatial range 212 may correspond to a range of heights at which the road boundary object 204 is located from a reference ground origin of the current driving road 202. As an example, the first spatial range 212 may employ a value equal to or less than a reference ground origin of the road 202 as a lower limit, or as another example, the first spatial range 212 may employ a point separated a predetermined space from the reference ground origin of the road 202 as the lower limit. An upper limit of the first spatial range 212 may be set based on a facility with a maximum height or a maximum size among facilities as the road boundary object 204. In addition, when a front road is a ramp, an upper limit of the first spatial range 212 may be defined to have a height range over a height at which the road boundary object 204 is located from a ground origin of a current driving road.

In order to maintain abnormal detection data belonging to the first spatial range 212, the processor 120 may remove abnormal detection data not belonging to the first spatial range 212.

In addition, when a lower limit of the first spatial range 212 has a value less than a ground origin of a current driving road, the processor 120 may remove detection data 214 corresponding to a road surface in the data by referring to image data for a camera or image data for observation. Depending on situations, the processor 120 may eliminate detection data 216 corresponding to an external static object of the road 202, for example, a building, a roadside tree, and the like.

Next, based on image data, the processor 120 may remove abnormal detection data in a second spatial range associated with an internal static object from the selected abnormal detection data (S210).

Image data, which is referred to in removing the abnormal detection data 210 associated with an internal static object, may be image data for a camera or image data for observation obtained from the 3D recognition sensor 104a.

As described above, the abnormal detection data 210 associated with an internal static object may be caused by a property of an internal static object. For example, as a line and a traffic mark on the road may have a high reflectance, detection data obtained from the Lidar sensor 104a may be frequently measured to be higher than an actual road surface. Detection data thus measured to be higher is not measured to match actual locations of lines and traffic marks and thus may correspond to abnormal detection data. Furthermore, in case the abnormal detection data 210 of an internal static object belongs to the first spatial range 212, distinction confusion of the processor 120 may occur between abnormal detection data 208 and 210 for the road boundary object 204 and the internal static object. Accordingly, the abnormal detection data 210 of the internal static object needs to be eliminated, and an eliminated range may be defined by a second spatial range. A second spatial range may be set by considering a range, in which abnormal detection data is caused by a property of an internal static object, and a range that minimizes recognitive confusion with abnormal detection data of the road boundary object 204. In consideration of what is described above, for example, a second spatial range may be set to be the same as the first spatial range 212.

The processor 120 may identify an internal static object in image data and remove abnormal detection data of a second spatial range corresponding to an image region of the identified internal static object. Herein, for example, in order to reduce the effect of abnormal detection data of an internal static object, an image region of the internal static object may be designated to include both a shape of the internal static object and a nearby zone adjacent to the shape. As another example, an image region of an internal static object may be set to actually correspond to a shape of the internal static object. The processor 120 may remove abnormal detection data of an internal static object that belongs both to an image region of the internal static object and to a second spatial range.

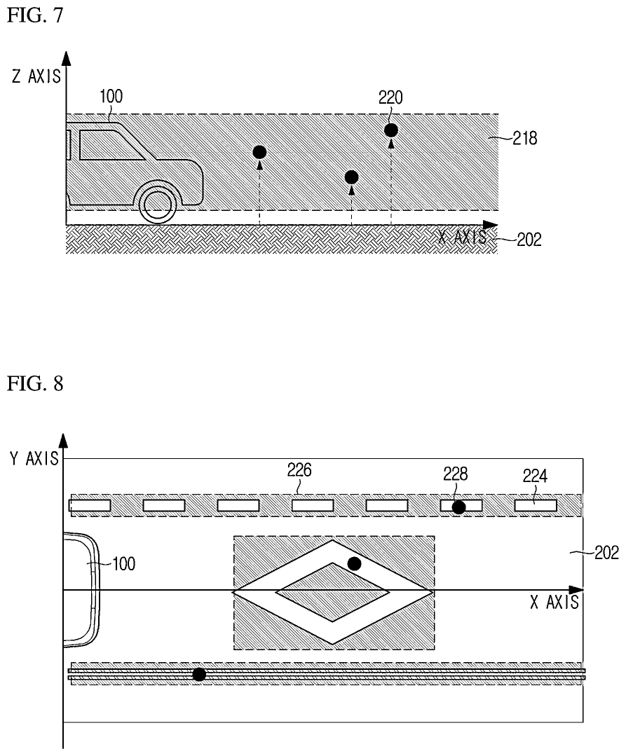

FIG. 7 is a view illustrating abnormal detection data of an internal dynamic object of a road located in a second spatial range in front of a vehicle. FIG. 8 is a view illustrating removal of abnormal detection data of an internal dynamic object of a road. In this example, image data is described as image data for a camera.

The processor 120 may identify the abnormal detection data 220, which belongs to the second spatial range 218, among abnormal detection data of the first spatial range 212. In case the second spatial range 218 is the same as the first spatial range, the processor 120 may employ all abnormal detection data of the first spatial range 212.

The processor 120 may identify an internal static object 224 by referring to image data for a camera and may also allocate an image region 226 of the internal static object 224 that is designated as a predetermined zone. The processor 120 may specify abnormal detection data 228 associated with the internal static object 224, which belongs both to the image region 226 and to the second spatial range 218, and may eliminate the specified abnormal detection data 228.

Next, the processor 120 may remove abnormal detection data associated with an internal dynamic object from abnormal detection data selected through the above-described step, based on image data or information on a change of the internal dynamic object (S215).

Image data, which is referred to in removing abnormal detection data associated with an internal dynamic object, may be image data for a camera or image data for observation obtained from the 3D recognition sensor 104a. For example, information on a change of an internal dynamic object may be generated based on a behavior of the object detected in radar data. Specifically, information on a change may be a relative speed of an internal dynamic object, a motion direction, and the like, which are generated based on a motion of the object included in radar data, a distance between the vehicle 100 and the object, a speed of the object, and a moving direction of the object.

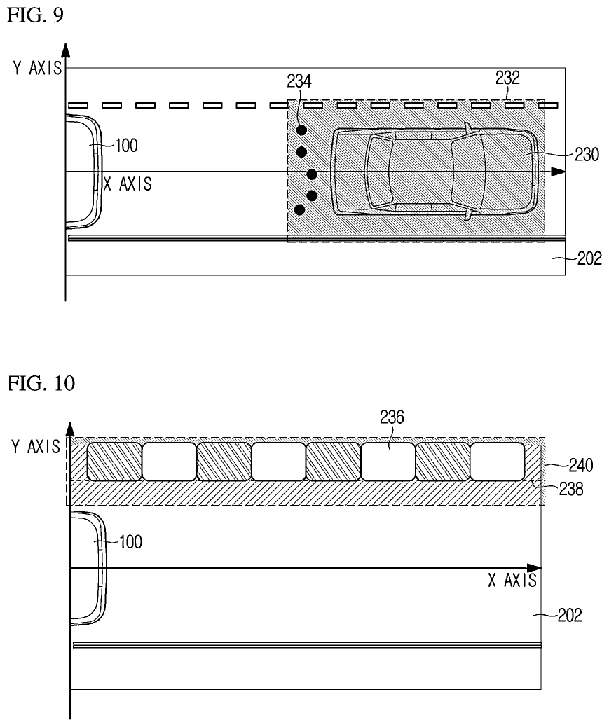

Removal of abnormal detection data associated with an internal dynamic object is described with reference to FIG. 9. FIG. 9 is a view illustrating removal of abnormal detection data associated with an internal dynamic object based on image data. In this example, image data for a camera is described to be used to remove abnormal detection data.

The processor 120 may identify an internal dynamic object 230 moving around the vehicle 100, i.e., a neighbor dynamic object, in image data for a camera and designate an image region 232 of the identified internal dynamic object, which includes the internal dynamic object 230 and a zone adjacent thereto. For example, the image region 232 of an internal dynamic object may be designated such that, based on a driving direction of a front vehicle illustrated as the neighbor dynamic object 230, a rear region located near the neighbor dynamic object 230 is larger than a front region located near the neighbor dynamic object 230. When the neighbor dynamic object 230 running at a high speed is recognized by the Lidar sensor 104a, a trace-type unstable Lidar point may be generated along a driving direction. Such an unstable Lidar point, i.e., abnormal detection data may cause confusion to distinction from abnormal detection data of the road boundary object 204 that belongs to the first spatial range 212. Trace-type abnormal detection data tends to occur more frequently in a rear region of the neighbor dynamic object 230 than in a front region. Accordingly, an image region 262 for filtering may be set by considering the above-described tendency. In addition, for example, a rear region and a front region may be dynamically configured based on information on a change of the neighbor dynamic object 230. For example, information on a change may include at least one of a distance to the vehicle 100, a relative speed, and a motion direction.

The processor 120 may specify abnormal detection data 234 associated with the neighbor dynamic object 232, which belongs both to the image region 232 of the neighbor dynamic object 230, and may eliminate the specified abnormal detection data 234.

As an embodiment different from the above description, when removing abnormal detection data of a neighbor dynamic object based on information on a change of the neighbor dynamic object 232, the processor 120 may set a filtering region in a space system where abnormal detection data exists, based on information on a change including a relative distance of the neighbor dynamic object 230, a relative speed, and a motion direction. A filtering region may be generated to include a region where a group of detection data estimated as a neighbor dynamic object in a space system, i.e., point clouds are distributed, a nearby front zone, and a nearby rear zone. As described above, a rear zone may be generated to be larger than a front zone. As a modified example, a filtering region may also be generated by fusing and using all the information on a change and image data.

Next, by referring to a boundary region based on a road boundary object identified from image data, the processor 120 may determine candidate detection data by filtering abnormal detection data that remains after the removal at the above-described step (S220).

Image data, which is used to determine candidate detection data using a boundary region, may be image data for a camera or image data for observation obtained from the 3D recognition sensor 104a. A boundary region may be set such that an external region of a road is larger than an internal region facing the road, based on a predetermined line of the road boundary object adjacent to the road identified in image data. This is because image data, for example, image data for a camera has a lower distance accuracy than 3D recognition data. For accuracy of recognition and distinction, as another example, a boundary region may be configured such that an internal region is larger than an external region based on a predetermined line.

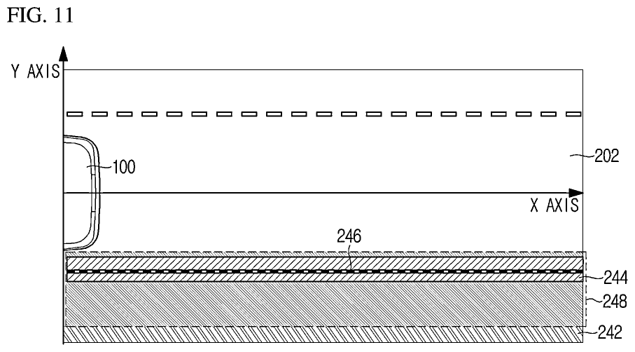

Referring to examples in FIG. 10 and FIG. 11, determination of candidate detection data is described. FIG. 10 is a view showing an example of a boundary region of image data based on a road boundary object. FIG. 11 is a view showing another example of a boundary region of image data based on a road boundary object. In this example, image data for a camera is described to be used to determine candidate detection data.

Referring to FIG. 10, the processor 120 may identify a road boundary object, for example, a shock absorbing structure 236 in image data for a camera and designate a predetermined line 238 associated with the shock absorbing structure 236 in the image data for a camera. The designated line 238 may be a line where the shock absorbing structure 238 adjoins a road surface, but the line may be set in various ways in consideration of a resolution of the image data, efficiency of a resource, and accuracy of recognition and distinction.

The processor 120 may set a boundary region 240 including an area corresponding to the shock absorbing structure 236 and a nearby zone thereof. The nearby zone may include, based on the designated line 238, an external region of the road 202, i.e., a zone outside the road 202, which is adjacent to and overlaps at least a part of the shock absorbing structure 236, and an internal region of the road 202, i.e., a zone that is adjacent to the shock absorbing structure 236 and faces the inside of the road 202. An external region may be set to be larger than an internal region.

The processor 120 may filter abnormal detection data other than the boundary region 240 of image data for a camera in order to make abnormal detection data overlapping the boundary region 240 remain and may determine the remaining abnormal detection data as candidate detection data.

Referring to FIG. 11, the processor 120 may identify a road boundary object, for example, a curb that divides a sidewalk 242 and the road 202, in image data for a camera and designate a predetermined line 246 associated with the curb 244 in the image data for a camera. The designated line 246 may be a line where the curb 244 adjoins a road surface, but the line may be set in various ways in consideration of a resolution of the image data, efficiency of a resource, and accuracy of recognition and distinction.

The processor 120 may set a boundary region 248 including an area corresponding to the curb 244 and a nearby zone thereof. The nearby zone may include an external region of the road 202 based on the designated line 244, i.e., a zone outside the road that overlaps at least a part of the curb 244 and is also adjacent thereto (e.g. the sidewalk 242) and an internal region of the road 202, i.e., a zone that is adjacent to the curb 244 and faces the inside of the road 202. An external region may be set to be larger than an internal region.

The processor 120 may filter abnormal detection data other than the boundary region 248 of image data for a camera in order to make abnormal detection data overlapping the boundary region 248 remain and may determine the remaining abnormal detection data as candidate detection data.

Referring to FIG. 3 again, the processor 120 may adopt estimated boundary data that is considered a road boundary object in candidate detection data, based on distribution information of normal boundary data that is normally perceived in relation to the road boundary object 204 (S120).

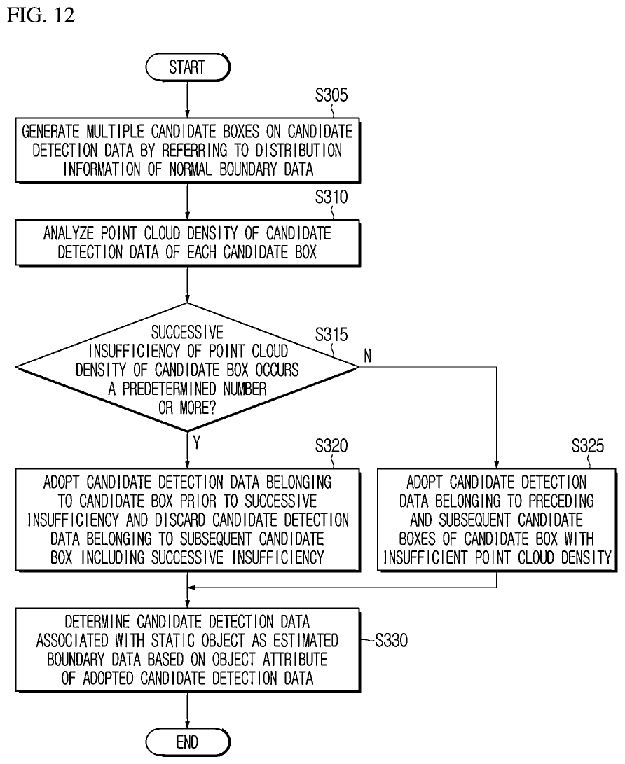

Regarding step S120, FIG. 12 is described below. FIG. 5 is a flowchart of a procedure for determining candidate detection data. FIG. 12 is a flowchart of a procedure for determining estimated boundary data.

First, the processor 120 may generate a plurality of candidate boxes in candidate detection data, based on distribution information of normally recognized normal boundary data associated with the road boundary object 204, in a space system where detection data exists (S305).

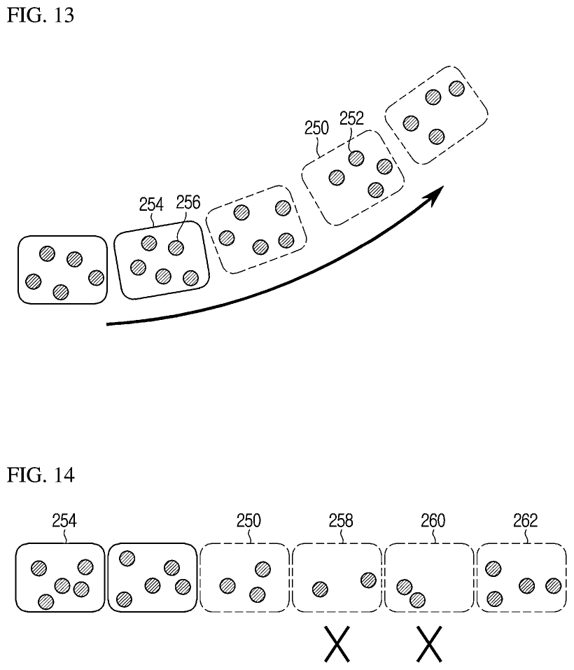

FIG. 13 is a view illustrating a candidate box generated on candidate detection data. Referring to FIG. 13 for describing a candidate box, the processor 120 may consider distribution information of a point cloud constituting normal boundary data 256 and may generate a normal box 254 on a plurality of normal boundary data 256 to surround these data. For example, distribution information may be a generation direction of point clouds, a point cloud density, and a density size.

In addition, the processor 120 may identify candidate detection data that is actually continuous with the normal box 254 and the normal boundary data 256, based on a generation direction of the normal box 254 and distribution information of normal boundary data. Actual continuity may mean including not only arrangement of continuous candidate detection data but also arrangement of candidate detection data with discontinuity of a predetermined space or above.

On candidate detection data that are actually continuous, the processor 120 may generate a candidate box 250 surrounding these data.

Next, the processor 120 may analyze a point cloud density of candidate detection data 252 according to each candidate box 250 (S310) and may determine whether or not successive insufficiency according to a point cloud density of the candidate box 250 occurs a predetermined number of times or more (S315).

If a point cloud density of the candidate detection data 252 included in the candidate box 250 is equal to or less than a threshold density, the processor 120 may determine that the point cloud density of the candidate box 250 is insufficient. Successive insufficiency may mean that candidate boxes with insufficient point cloud densities occur successively. A numbers for determining successive insufficiency may be determined according to a configuration of the processor 120 and may be set, for example, to 2 or above.

In case successive insufficiency occurs a predetermined number of times or more (Y in S315), the processor 120 may adopt candidate detection data belonging to a candidate box preceding a candidate box, in which the successive insufficiency begins, and may discard candidate detection data belonging to a succeeding candidate box including the successive insufficiency (S320).

FIG. 14 is a view illustrating an example of selecting a candidate box and adopting candidate detection data. As shown in FIG. 14, candidate boxes 258 and 260, which are determined to have insufficient point cloud densities, are successive, for example, twice or more times. The processor 120 may adopt the candidate detection data 252 belonging to the candidate box 250 preceding the candidate box 258, in which successive insufficiency begins, and may not select all the detection data 252 that belong to the candidate boxes 258 and 260, which are determined to have insufficient point cloud densities, and a succeeding candidate box 262.

In case successive insufficiency occurs less frequently than a predetermined number of times (N in S315), the processor 120 may adopt candidate detection data, which belong to a candidate box preceding a candidate box with an insufficient point cloud density and a candidate box succeeding the candidate box with the insufficient point cloud density, and may exclude candidate detection data of the candidate box with the insufficient point cloud density (S325).

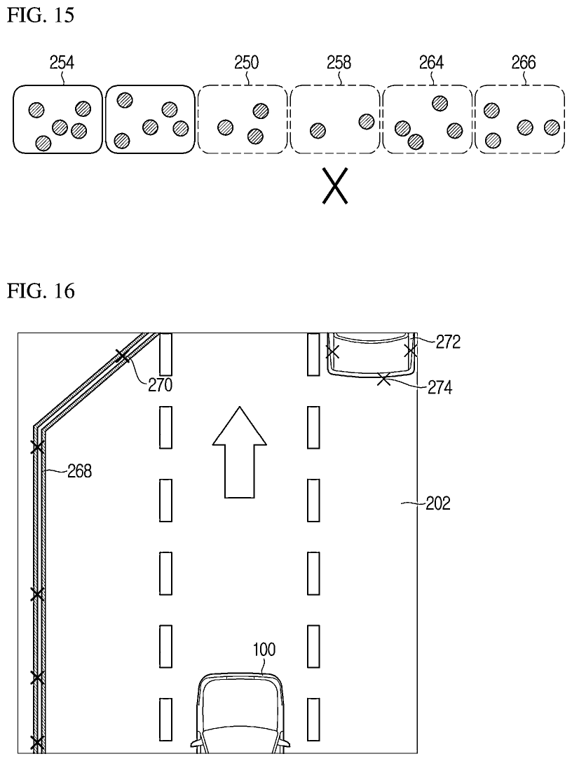

FIG. 15 is a view illustrating another example of selecting a candidate box and adopting candidate detection data. As shown in FIG. 15, in case the candidate box 258, which is determined to have an insufficient point cloud density, is successive less frequently than, for example, 1, the processor 120 may adopt only the candidate detection data 252 belonging to other candidate boxes 250, 264 and 266, i.e., preceding and succeeding candidate boxes 250, 264 and 266, excluding the candidate box 258 with the insufficient point cloud density. By skipping the insufficient candidate box and selecting another candidate box, even if candidate detection data of the selected candidate box is used as valid data with respect to connectivity to normal boundary data, there may be a low possibility that an error occurs in subsequent processing.

Next, the processor 120 may determine candidate detection data associated with a static object as estimated boundary data, based on an object attribute of the adopted candidate detection data (S330).

The processor 120 may identify the object attribute of the adopted candidate detection data based on, for example, information associated with a behavior of an object obtained from radar data. For example, information associated with a behavior of an object may include whether or not the object moves, a relative speed of the object, a motion direction, and the like. The processor 120 may consider an object attribute of candidate detection data, in which a motion is detected due to a constant or changing relative distance to the vehicle 100 while a relative speed changes, as a dynamic object. On the other hand, the processor 120 may consider an object attribute of candidate detection data, in which no motion is estimated based on a relative speed, as a static object. As another example, when identifying an object attribute, the processor 120 may infer an object attribute of overall candidate detection data belonging to a candidate box based on a relative speed for the candidate box surrounding candidate detection data.

The processor 120 may finally determine candidate detection data, which is determined as a static object, as estimated boundary data.

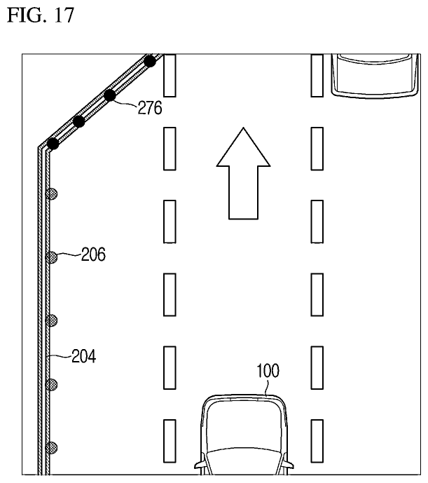

FIG. 16 is a view illustrating determination of estimated boundary data based on an object attribute of candidate detection data. Based on an object behavior included in radar data, the processor 120 may identify an object attribute of candidate detection data present in a space system. Based on radar data corresponding to candidate detection data 270 near the road boundary object 204, the processor 120 may estimate an object attribute of the candidate detection data 270 as a static object. The processor 120 may adopt the candidate detection data 270, which is estimated as a static object, as estimated boundary data.

Meanwhile, in case a neighbor vehicle 272 is near the road boundary object 204, even after the filtering of the preceding steps, abnormal detection data associated with the neighbor vehicle 272 may be present as candidate detection data. In this regard, the processor 120 excludes candidate detection data that is estimated as a dynamic object according to an object attribute of candidate detection data. As shown in FIG. 16, based on radar data associated with candidate detection data 274 on the neighbor vehicle 272, the processor 120 may estimate an object attribute of the candidate detection data 274 as a dynamic object. The candidate detection data 274 on the neighbor vehicle 272 may be excluded from estimated boundary data.

In this embodiment, step S330 is described to be performed since at least a part of detection data of a dynamic object at step S110. Thus, candidate detection data adopted at step S320 and step S325 may correspond to data that is considered estimated boundary data in a subsequent process. In another embodiment, if all the detection data of the dynamic object at step S110 are eliminated, step S330 may be omitted according to a situation. Thus, candidate detection data adopted at step S320 and step S325 may be finally considered estimated boundary data, and this may be referred to a point where estimated boundary data is finally determined.

Referring to FIG. 3 again, the processor 120 may adopt the normal boundary data 206 and estimated boundary data 276 as boundary data and may perform predetermined processing for autonomous driving based on boundary data derived from the 3D recognition sensor 104a, image data for a camera, radar data, and location data (S125).

As illustrated in FIG. 17, the estimated boundary data 276 may be detection data that is effectively used together with the normal boundary data 206 in order to recognize the road boundary object 204. Accordingly, the estimated boundary data 276 and the normal boundary data 206 may be included in extended 3D recognition data of the road boundary object 204 and constitute boundary data.

Predetermined processing may be a task of estimating or determining a location of the vehicle 100 based on boundary data and the above-listed sensing data.

According to the present disclosure, utilization of detection data of a 3D recognition sensor may be increased by using detection data abnormally perceived in the 3D recognition sensor as valid detection data through fusion with other sensor data. In addition, when abnormal detection data is also applied to processing of autonomous driving, the safety of autonomous driving may be ensured, and user experience may also be improved.

While the methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for recognizing a road boundary object, the method comprising:
sensing an environment around a vehicle by an environment perception sensor, the environment perception sensor comprising a laser scanning-based three-dimensional recognition sensor and a sensor of a different type from the laser scanning-based three-dimensional recognition sensor;
determining candidate detection data from abnormal detection data that is perceived to be abnormal by the laser scanning-based three-dimensional recognition sensor and is unassociated with an internal static object of a road and an internal dynamic object of the road, by referring to a boundary region for perceiving a road boundary object;
adopting estimated boundary data that is considered as a road boundary object in the candidate detection data, based on distribution information of normal boundary data that is normally perceived in relation to the road boundary object by the laser scanning-based three-dimensional recognition sensor; and
employing the normal boundary data and the estimated boundary data as boundary data.

2. The method of claim 1, further comprising configuring the abnormal detection data as abnormal detection data located within a first spatial range in which the road boundary object is possible to exist.

3. The method of claim 1, wherein determining the candidate detection data comprises:
selecting abnormal detection data within a first spatial range in which the road boundary object is possible to exist;
removing, based on an image data of the environment perception sensor, abnormal detection data within a second spatial range associated with the internal static object from the selected abnormal detection data;
removing abnormal detection data associated with the internal dynamic object from the selected abnormal detection data, based on at least one of the image data or change information of the internal dynamic object; and
determining candidate detection data by filtering abnormal detection data that remains after removal, by referring to the boundary region based on the road boundary object identified from the image data.

4. The method of claim 3, wherein the environment perception sensor includes a camera configured to obtain an image of the environment and a radar sensor configured to detect a behavior of an object that belongs to the environment, and
wherein the method further comprises:
obtaining the image data by the camera or the laser scanning-based three-dimensional recognition sensor; and
obtaining the change information by the radar sensor.

5. The method of claim 3, wherein removing the abnormal detection data associated with the internal dynamic object includes removing abnormal detection data that remains in a predetermined region behind a neighbor dynamic object based on a driving direction of the neighbor dynamic object driving near the vehicle.

6. The method of claim 3, further comprising setting the boundary region to make an external region of the road larger than an internal region facing the road, based on a predetermined line of the road boundary object adjacent to the road identified in the image data.

7. The method of claim 3, wherein the first spatial range and the second spatial range are same,
wherein the first spatial range and the second spatial range are a range of a data space of a three-dimensional recognition data corresponding to a range of height in which the road boundary object is located from a reference ground origin of the road, and
wherein the data space is defined as a space system in which the three-dimensional recognition data exists.

8. The method of claim 1, wherein adopting the estimated boundary data comprises:
generating a plurality of candidate boxes on the candidate detection data based on the distribution information of the normal boundary data;
determining whether or not insufficiency, in which a point cloud density in the candidate boxes is equal to or less than a threshold density, successively occurs a predetermined number of times or more;
in response to an occurrence of successive insufficiency, adopting the candidate detection data, which belongs to a candidate box preceding a candidate box, in which the successive insufficiency begins, to be considered the estimated boundary data; and
in response to a non-occurrence of the successive insufficiency, adopting the candidate detection data, which belongs to a candidate box preceding an insufficient candidate box and a candidate box following the insufficient candidate box, to be considered the estimated boundary data.

9. The method of claim 8, further comprising determining the candidate detection data associated with a static object as the estimated boundary data, based on an object attribute of the adopted candidate detection data.

10. The method of claim 1, further comprising determining a location of the vehicle based on at least the boundary data.

11. A vehicle for recognizing a road boundary object, the vehicle comprising:
a sensor unit equipped with an environment perception sensor, the environment perception sensor comprising a laser scanning-based three-dimensional recognition sensor and a sensor of a different type from the laser scanning-based three-dimensional recognition sensor in order to sense a surrounding environment of the vehicle;
a memory configured to store at least one instruction for the vehicle; and
a processor configured to:
execute the at least one instruction stored in the memory;
determine candidate detection data from abnormal detection data that is perceived to be abnormal by the laser scanning-based three-dimensional recognition sensor and is unassociated with an internal static object of a road and an internal dynamic object of the road, by referring to a boundary region for perceiving the road boundary object;
adopt estimated boundary data that is considered as a road boundary object in the candidate detection data, based on distribution information of normal boundary data that is normally perceived in relation to the road boundary object by the laser scanning-based three-dimensional recognition sensor; and
employ the normal boundary data and the estimated boundary data as boundary data.

12. The vehicle of claim 11, wherein the abnormal detection data is configured as abnormal detection data located within a first spatial range in which the road boundary object is possible to exist.

13. The vehicle of claim 11, wherein the processor is further configured, when determining the candidate detection data, to:
select abnormal detection data within a first spatial range in which the road boundary object is possible to exist;
remove, based on an image data of the environment perception sensor, abnormal detection data within a second spatial range associated with the internal static object from the selected abnormal detection data;
remove abnormal detection data associated with the internal dynamic object from the selected abnormal detection data, based on at least one of the image data or change information of the internal dynamic object; and
determine candidate detection data by filtering abnormal detection data that remains after removal, by referring to the boundary region based on the road boundary object identified from the image data.

14. The vehicle claim 13, wherein the environment perception sensor includes a camera configured to obtain an image of the surrounding environment and a radar sensor configured to detect a behavior of an object that belongs to the surrounding environment, and
wherein the image data is obtained by the camera or the laser scanning-based three-dimensional recognition sensor, and the change information is obtained by the radar sensor.

15. The vehicle of claim 13, wherein when removing the abnormal detection data associated with the internal dynamic object, the processor is configured to remove abnormal detection data that remains in a predetermined region behind a neighbor dynamic object based on a driving direction of the neighbor dynamic object driving near the vehicle.

16. The vehicle of claim 13, wherein the boundary region is set to make an external region of the road larger than an internal region facing the road, based on a predetermined line of the road boundary object adjacent to the road identified in the image data.

17. The vehicle of claim 13, wherein the first spatial range and the second spatial range are same,
wherein the first spatial range and the second spatial range are a range of a data space of a three-dimensional recognition data corresponding to a range of height in which the road boundary object is located from a reference ground origin of the road, and
wherein the data space is defined as a space system in which the three-dimensional recognition data exists.

18. The vehicle of claim 11, wherein when adopting the estimated boundary data, the processor is configured to:
generate a plurality of candidate boxes on the candidate detection data based on the distribution information of the normal boundary data;
determine whether or not insufficiency, in which a point cloud density in the candidate boxes is equal to or less than a threshold density, successively occurs a predetermined number of times or more;
in response to an occurrence of successive insufficiency, adopt the candidate detection data, which belongs to a candidate box preceding a candidate box, in which the successive insufficiency begins, to be considered the estimated boundary data; and
in response to a non-occurrence of the successive insufficiency, adopt the candidate detection data, which belongs to a candidate box preceding an insufficient candidate box and a candidate box following the insufficient candidate box, to be considered the estimated boundary data.

19. The vehicle of claim 18, wherein the processor is further configured to determine the candidate detection data associated with a static object as the estimated boundary data, based on an object attribute of the adopted candidate detection data.

20. The vehicle of claim 11, wherein the processor is further configured to determine a location of the vehicle based on at least the boundary data.
